(19) United States
(12) Patent Application Publication
(10) Pub. No.: US 2026/0075683 A1
(43) Pub. Date: Mar. 12, 2026

(54) SUSCEPTOR ASSEMBLY AND SUBSTRATE PROCESSING APPARATUS

(71) Applicant: TES CO., LTD, Yongin-si (KR)

(72) Inventors: Wook-Hee LEE, Yongin-si (KR); Sung-Cheol KIM, Yongin-si (KR)

(73) Assignee: TES CO., LTD, Yongin-si (KR)

(21) Appl. No.: 19/324,016

(22) Filed: Sep. 9, 2025

(30) Foreign Application Priority Data
Sep. 12, 2024 (KR) 10-2024-0124804

(51) Int. Cl. H05B 6/10; H05B 6/14

(52) U.S. Cl. CPC H05B 6/105; H05B 6/14

(57) ABSTRACT

A susceptor assembly is configured to support a substrate and to regulate a temperature of the substrate. The susceptor assembly comprises a susceptor on which the substrate is seated. The susceptor is configured to cool or heat the substrate and to supply levitational gas toward the substrate. A substrate processing apparatus is provided to include the susceptor assembly, along with a chamber forming a processing space for the substrate and a gas supply unit provided in the chamber to supply process gas toward the substrate.

### CROSS-REFERENCE TO RELATED APPLICATIONS

A claim for priority under 35 U.S.C. § 119 is made to Korean Patent Application No. 10-2024-0124804 filed on Sep. 12, 2024, in the Korean Intellectual Property Office, the entire contents of which are hereby incorporated by reference.

### BACKGROUND OF THE INVENTION

### Field of the Invention

The present invention relates to a susceptor assembly and a substrate processing apparatus, and more particularly to the susceptor assembly and the substrate processing apparatus capable of effectively performing processes such as etching on a substrate by easily controlling a temperature of the substrate.

### Description of the Related Art

Generally, when various processes are performed on a substrate inside a chamber, it is necessary to heat the substrate to a process temperature. In addition, when a temperature of the substrate is regulated, it is important to maintain temperatures of a center and a periphery of the substrate at a constant level so that no temperature difference occurs.

For example, in an equipment used for etching the substrate, etching gases such as Hydrofluoric Acid (HF) and Ammonia (NH₃) are supplied toward the substrate, and a substrate surface is etched through reactions between HF and NH₃. The process by-products generated during etching are then heated and removed.

In this case, a process of etching the substrate may be performed at a low temperature of approximately 30° C. to 40° C., while a process of removing the process by-products may be performed at a high temperature of approximately 100° C. or higher.

In a substrate processing apparatus according to the prior art, separate cooling passages or paths are provided at a center and a periphery of a susceptor, respectively. In this case, due to differences in flow speeds of the cooling fluid in the cooling paths at the center and the periphery and differences in flow rates of the cooling fluid in the cooling paths at the center and the periphery, it was difficult to maintain the temperatures of the center and the periphery of the substrate to be uniform or constant by using the cooling fluid.

As a result, as a process cycle for the substrate increases, deviations due to temperature differences accumulate, making it difficult to effectively perform the process on the substrate. Therefore, when the process is performed on the substrate, it is important to maintain the temperatures at the center and periphery of the substrate to be constant or to be the same, with no temperature differences.

### SUMMARY OF THE INVENTION

The present invention is contemplated to solve problems in the prior art mentioned above. Thus, it is an object of the present invention to provide a susceptor assembly and a substrate processing apparatus capable of maintaining temperatures of a center and a periphery of a substrate at a constant level.

In addition, it is an object of the present invention to provide a susceptor assembly and a substrate processing apparatus capable of rapidly raising a temperature of a substrate by floating or levitating the substrate above a susceptor when a high temperature process is performed after a low temperature process.

To solve the above problems, the present invention may provide a susceptor assembly configured to support a substrate and to regulate a temperature of the substrate, the susceptor assembly comprising: a susceptor on which the substrate is seated, the susceptor being configured to cool or heat the substrate and to supply levitational gas toward the substrate.

The susceptor assembly may further comprise two or more zone heaters embedded in the susceptor and configured to heat the substrate; and a cooling path disposed between the zone heaters and configured to allow cooling fluid to flow therethrough to cool the substrate.

The zone heaters may include: a first zone heater configured to heat a center portion of the substrate; and a second zone heater configured to heat a periphery of the substrate. Further, the cooling path may be disposed between the first zone heater and the second zone heater in the susceptor.

A plurality of supply holes may be formed at an upper surface of the susceptor to supply the levitational gas toward a lower surface of the substrate, and a reception space for accommodating the levitational gas and communicating with the supply holes, may be provided in an interior of the susceptor.

The susceptor assembly may further comprise a plurality of anti-dislodgement pins configured to prevent the substrate from dislodging from the susceptor, while the substrate is floated or levitated above the susceptor.

The susceptor may include: an upper susceptor on which the substrate is seated; and a lower susceptor configured to support the upper susceptor. In this case, the upper susceptor may include: two or more zone heaters configured to heat the substrate; and a cooling path disposed between the zone heaters and configured to allow cooling fluid to flow therethrough to cool the substrate.

Further, in this case, a plurality of supply holes may be formed at an upper surface of the upper susceptor to supply the levitational gas toward a lower surface of the substrate, and a reception space for accommodating the levitational gas and communicating with the supply holes, may be provided between the upper susceptor and the lower susceptor.

Meanwhile, to solve the above problems, the present invention may further provide a substrate processing apparatus comprising: a chamber configured to provide a processing space for a substrate; a gas supply unit provided in an upper portion of an interior of the chamber and configured to supply process gas toward the substrate; and a susceptor assembly provided in the interior of the chamber and configured to allow the substrate to be seated thereon, wherein the susceptor assembly includes: a susceptor on which the substrate is seated, the susceptor being configured to cool or heat the substrate and to supply levitational gas toward the substrate; two or more zone heaters embedded in the susceptor and configured to heat the substrate; and a cooling path disposed between the zone heaters and configured to allow cooling fluid to flow therethrough to cool the substrate.

A plurality of supply holes may be formed at an upper surface of the susceptor to supply the levitational gas toward a lower surface of the substrate, and a reception space for accommodating the levitational gas and communicating with the supply holes, may be provided in an interior of the susceptor.

The gas supply unit may be provided with a lamp configured to heat the substrate.

Details of examples or implementations will be described in the following with reference to the accompanying drawings. Other features will be apparent from the description and drawings, and from the claims.

### BRIEF DESCRIPTION OF THE DRAWINGS

The present invention will become more fully understood from the detailed description given below and the accompanying drawings, which are given by illustration only, and thus are not intended to limit the scope of the present Invention, wherein:

FIG. 1 is a side sectional view of a substrate processing apparatus with a susceptor assembly, according to one embodiment of the present invention;

FIG. 2 is a top perspective view of the susceptor assembly;

FIG. 3 is a partially enlarged sectional view of the susceptor assembly; and

FIG. 4 is a side sectional view of the substrate processing apparatus showing the substrate in a floated state in FIG. 1.

### DETAILED DESCRIPTION OF THE PREFERRED EMBODIMENT

Description for the present invention will now be given in detail according to examples disclosed herein, with reference to the accompanying drawings.

For the sake of a brief description with reference to the drawings, the same or equivalent components may be provided with the same reference numbers, and description thereof will not be repeated. In the following, any conventional art which is well-known to one of ordinary skill in the relevant art has generally been omitted for the sake of brevity. The accompanying drawings are used to help easily understand various technical features and it should be understood that the examples presented herein are not limited by the accompanying drawings. As such, the present invention should be construed to extend to any alterations, equivalents, and substitutes in addition to those which are particularly set out in the accompanying drawings.

A singular representation may include a plural representation unless it represents a definitely different meaning from the context.

It will be understood that although the terms “first,” “second,” etc., may be used herein to describe various components, these components should not be limited by these terms. These terms are only used to distinguish one component from another component.

It should be understood that when a component is referred to as being “connected to” or “coupled to” another component, this component may be directly connected to or coupled to another component, or any intervening components may be present between the components. In contrast, when a component is referred to as being “directly connected to” or “directly coupled to” another component, there are no intervening components present.

Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present invention includes any combinations of features, numerals, steps, operations, components, parts and the like partially omitted from the related or involved features, numerals, steps, operations, components, and parts described using the aforementioned terms unless deviating from the intentions of the original disclosure.

Hereinafter, a configuration of a susceptor assembly and a substrate processing apparatus according to an embodiment of the present invention will be described with reference to drawings.

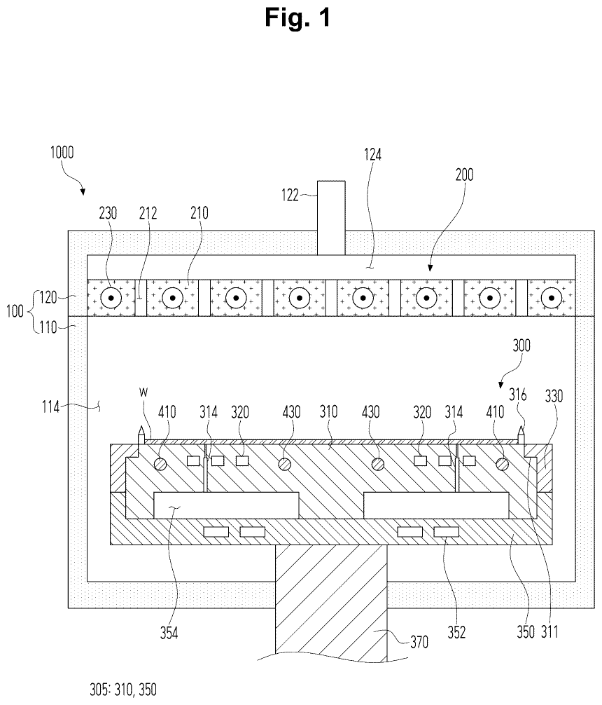

FIG. 1 is a side sectional view of a substrate processing apparatus 1000 to which a susceptor assembly 300 is applied, according to one embodiment of the present invention.

In the present specification, the substrate processing apparatus 1000 to which the susceptor assembly 300 may be provided, may correspond to an apparatus for etching a substrate W and removing by-products on the substrate W by thermal treatment. However, the description of the substrate processing apparatus 1000 herein is only an example, and the susceptor assembly 300 according to the present invention may be applied to any apparatus requiring temperature control of the substrate W and is not limited to an etching and post-processing apparatus.

Referring to FIG. 1, the substrate processing apparatus 1000 may comprise a chamber 100 providing a processing space 114 for the substrate W, a gas supply unit 200 provided in an upper portion of an interior of the chamber 100 to heat the substrate W, and a susceptor assembly 300 provided in the interior of the chamber 100 to allow the substrate W to be seated or rested thereon.

The chamber 100 may receive and accommodate the substrate W and may provide the processing space 114 for the substrate W. The chamber 100 may include, for example, a chamber body 110 having an open top or upper portion, and a chamber lid 120 closing and sealing the open top portion of the chamber body 110.

A lower portion of the interior of the chamber 100 may be provided with a susceptor assembly 300 on which the substrate W is seated.

Further, a gas supply line 122 for supplying process gas and the like may be connected to an upper portion (or a top portion) of the chamber 100. The gas supply line 122 may be connected, for example, to the chamber lid 120.

The process gas or etching gas or the like supplied via the gas supply line 122 may be diffused in a diffusion space 124 between the chamber lid 120 and the gas supply unit 200, and may be supplied towards the substrate W via the gas supply unit 200.

Meanwhile, the gas supply unit 200 may include a lamp 230 which is configured to heat the substrate W.

For example, the gas supply unit 200 may include a cover portion 210, and a plurality of lamps 230 provided to the cover portion 210. The cover portion 210 may be composed of quartz and the like, and the material for the cover portion 210 is not particularly limited. The lamp 230 may include the plurality of lamps which are disposed in the cover portion 210.

Further, the gas supply unit 200 may include a supply slit 212 for supplying the process gas or etching gas or the like from the diffusion space 124 described above toward the substrate W located below. The supply slit 212 may be formed by penetrating the cover portion 210 from a top to a bottom thereof.

The above configuration of the gas supply unit 200 is described by way of example only, and may be applied in various modifications.

Meanwhile, when an etching process is performed on the substrate W, the etching gas may be supplied toward the substrate W. For example, the etching gas may comprise Hydrofluoric Acid (HF) and Ammonia (NH₃) and the like.

When the etching gas comprising HF and NH₃ is supplied to the substrate W, the etching gas is changed into Ammonium Fluoride (NH₄F) by the reaction as shown in [Formula 1] below.

$$HF + {NH}_{3} \to {NH}_{4} F \qquad [ Formula 1 ]$$

Ammonium Fluoride (NH₄F) reacts with the substrate W to produce the process by-products on an upper surface (or a top surface) of the substrate (W) together with a predetermined amount of water and Ammonia as shown in [Formula 2] below.

$$6 {NH}_{4} F + {SiO}_{2} \to {( {NH}_{4} )}_{2} {SiF}_{6} ( s ) + 2 {H}_{2} O ( g ) + 4 {NH}_{3} ( g ) \qquad [ Formula 2 ]$$

The above reaction, i.e., the reaction in which the process by-products are generated on the upper surface of the substrate W by supplying the etching gas comprising HF and NH₃ to the substrate W, may be carried out at a low temperature of approximately 30° C. to 40° C.

However, the process by-products generated on the upper surface of the substrate W may be sublimated and removed by reacting as shown in following [Formula 3] at a high temperature, approximately 100° C. or higher.

$${( {NH}_{4} )}_{2} {SiF}_{6} ( s ) \to 2 {NH}_{3} ( g ) + {SiF}_{4} ( g ) + 2 HF ( g ) \qquad [ Formula 3 ]$$

However, a substrate processing apparatus according to the prior art has difficulty in cooling the substrate W to perform a low temperature process according to [Formula 1] and [Formula 2] after a high temperature process according to [Formula 3].

That is, when the etching is performed by the low temperature process on the substrate, it is necessary to maintain a uniform temperature of the substrate, and in the apparatus according to the prior art, it is difficult to maintain temperatures of a center and a periphery of the substrate to be uniform or to be the same.

For example, in the apparatus according to the prior art, separate cooling paths, passages, or channels were provided to a center and a periphery of a susceptor, respectively, and in this case, it was difficult to maintain the temperatures of the center and the periphery of the substrate to be uniform or to be the same by using the cooling fluid, due to differences in flow speeds of cooling fluid (i.e., coolant) in the cooling paths of the center and the periphery and differences in flow rates of the cooling fluid in the cooling passages of the center and the periphery.

In this case, as a process cycle for the substrate increased, deviation caused by the temperature differences described above accumulated, and therefore it was difficult for the process for the substrate to proceed effectively.

The present invention seeks to provide a susceptor assembly capable of uniformly regulating the temperature of the substrate when a temperature change of the substrate or a temperature control of the substrate is required as the process on the substrate is repeated as described above.

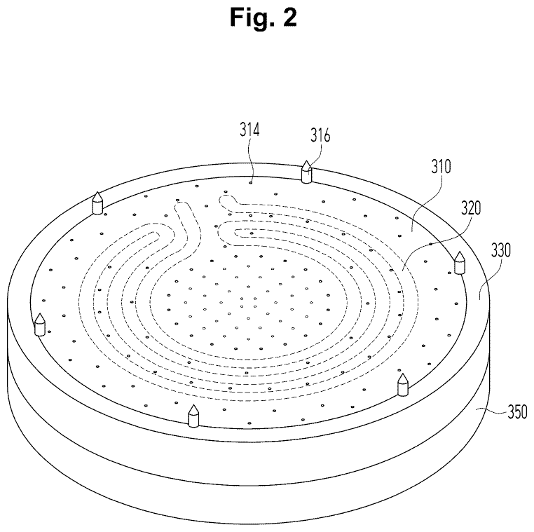

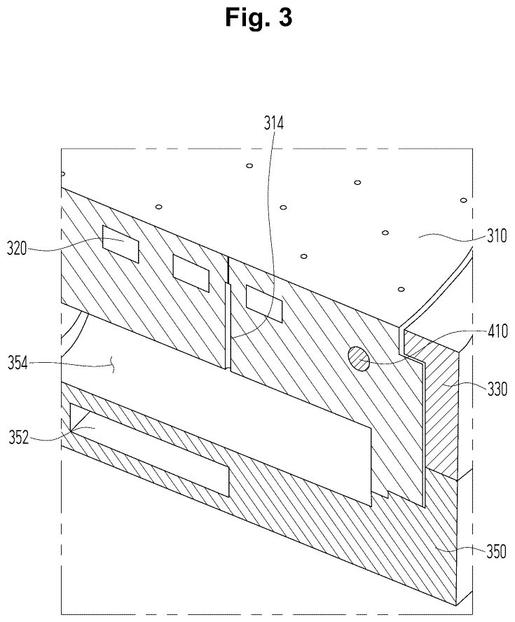

FIG. 2 is a top perspective view of the susceptor assembly 300, and FIG. 3 is a partially enlarged sectional view of the susceptor assembly 300.

Referring to FIGS. 1 to 3, the susceptor assembly 300 may comprise a susceptor 305 on which the substrate W is mounted or seated, which heats or cools the substrate W, and which supplies levitational gas to the substrate W.

In this case, the susceptor 305 may include two or more zone heaters 410, 430 for heating the substrate W, and a cooling path 320 disposed between the zone heaters 410, 430 through which cooling fluid or coolant flows to cool the substrate W. Particularly, the zone heaters 410, 430 and the cooling path 320 may be embedded in the susceptor 305.

The susceptor assembly 300 according to the present embodiment, when equipped with a cooling path, may include a single cooling path 320, and such a single cooling path 320 may be disposed between the plurality of zone heaters 410, 430.

In the present invention, in which the cooling path 320 is configured as the single path, the temperature of the substrate W may be easily controlled by preventing a flow speed difference or a flow rate difference of the cooling fluid, compared to the case of having separate cooling paths.

A supply line (not shown) for supplying the cooling fluid may be connected to the cooling path 320 along a support bar 370 extending downwardly from the susceptor assembly 300. The cooling fluid may be supplied to the cooling path 320 by on/off control of pumping means (not shown) that supplies the cooling fluid along the supply line.

Meanwhile, the zone heaters 410, 430 may be configured as resistance heaters, for example, but not limited thereto.

If it is desired to increase the temperature of the substrate W, the zone heaters 410, 430 may be driven to heat the substrate W. On the other hand, if it is desired to decrease the temperature of the substrate W, the cooling fluid of the cooling path 320 may be utilized.

In this case, the zone heaters 410, 430 may include a first zone heater 430 that heats the center portion of the substrate W, and a second zone heater 410 that heats a periphery of the substrate W.

That is, the center portion of the substrate W may be heated by the first zone heater 430, and the periphery of the substrate W may be heated by the second zone heater 410.

The cooling path 320 may be disposed between the first zone heater 430 and the second zone heater 410 in the susceptor 305.

Meanwhile, the susceptor 305 may include an upper susceptor 310 on which the substrate W is rested or seated, and a lower susceptor 350 supporting the upper susceptor 310.

On a top potion (or an upper portion) of the lower susceptor 350, the upper susceptor 310 may be seated, and an annular retaining (or fixing) ring 330 may be seated on a step 311 formed on an periphery of the upper susceptor 310 to secure the upper susceptor 310. A lower portion (or bottom portion) of the retaining ring 330 may be connected to the lower susceptor 350.

The lower susceptor 350 may be formed with a temperature control path (or thermostatic path) 352 through which temperature control fluid (or thermostatic fluid) flows for regulating the temperature of the susceptor 305.

In the above configuration, the zone heaters 410, 430 and the cooling path 320 may be provided in the upper susceptor 310.

Meanwhile, after performing the etching process on the substrate W, that is, the etching process in which the process by-products as described above are generated, when a post-treatment process for removing the process by-products from the substrate W is performed, if the substrate W is settled in the susceptor 305, it is not easy to raise the temperature of the substrate W due to the low temperature of the susceptor 305. This is because there is the cooling fluid flowing in the cooling path 320 of the susceptor 305.

Therefore, in the present invention, by floating, levitating, or suspending the substrate W (i.e., by allowing the substrate W to hover above the susceptor 305) by supplying the levitational gas toward the bottom surface (or lower surface) of the substrate W using the susceptor assembly 300, the substrate W can be heated while prevented from contacting the susceptor 305.

For example, a plurality of supply holes 314 may be formed at an upper surface (or a top surface) of the susceptor 305 to supply the levitational gas toward the bottom surface of the substrate W. In this case, a reception space 354 for receiving and accommodating the levitational gas and communicating with the supply holes 314 may be formed in an interior of the susceptor 305.

For example, a supply line (not shown) for supplying the levitational gas may be connected to the reception space 354 along the support bar 370 extending downwardly from the susceptor assembly 300. The levitational gas may be supplied through the supply hole 314 by on/off control of the supply line, or by on/off control of pumping means (not shown) that supplies the levitational gas along the supply line.

In the susceptor 305 including the upper susceptor 310 and the lower susceptor 350 as described above, the supply holes 314 may be formed in the upper substrate 310, and the reception space 354 may be formed between the upper substrate 310 and the lower substrate 350.

The levitational gas may comprise gas that does not affect the process on the substrate W, and may comprise, for example, but not limited to, an inert gas.

Meanwhile, when the substrate W is floated, levitated or suspended above the susceptor 305 by the levitational gas (i.e., the substrate W hovers above the susceptor 305), it may be dislodged from the susceptor 305. Therefore, the upper (or top) surface of the susceptor 305, i.e., an upper surface of the upper susceptor 310, may be provided with a plurality of anti-dislodgement pins 316 that prevent the substrate W from dislodging from the susceptor 305.

The anti-dislodgement pins 316 may be disposed spaced apart along an periphery of the upper susceptor 310.

Hereinafter, the etching process for the substrate W by the substrate processing apparatus 1000 having the configuration as described above, will be described.

First, as shown in FIG. 1, the substrate W may be seated on the upper (or top) surface of the susceptor 305. In this case, no levitational gas is supplied toward the bottom surface of the substrate W, and the substrate W remains seated on the top surface of the susceptor 305 (or on the top surface of the upper susceptor 310).

In the state as shown in FIG. 1, the cooling fluid may flow along the cooling path 320 of the susceptor 305 to adjust the temperature of the substrate W to a first process temperature, for example, approximately 30° C. to 40° C.

Subsequently, the process gas may be supplied to the substrate W. For example, the etching gas comprising HF and NH₃ may be supplied to the substrate W.

In this case, the process by-products may be generated on the substrate W by the reactions according to [Formula 1] and [Formula 2].

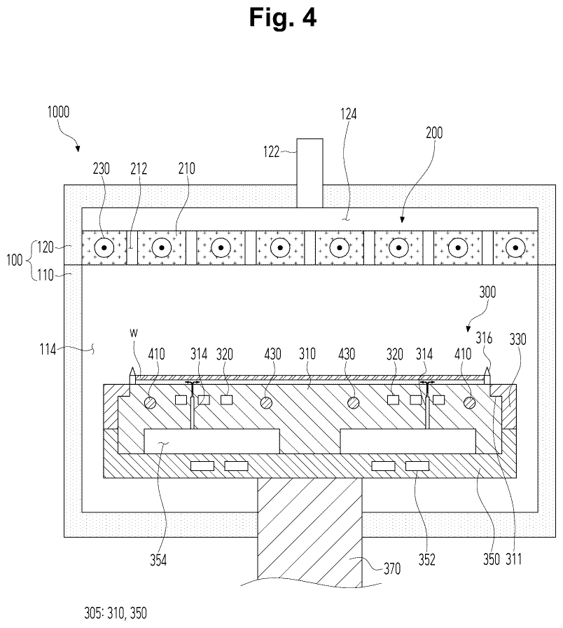

Then, the levitational gas is supplied toward the bottom surface of the substrate W to cause the substrate W to float, levitate, or hover above the susceptor 305, as shown in FIG. 4. By floating, levitating, or suspending the substrate W above the susceptor 305 which has a relatively low temperature and thus spacing the substrate W apart from such a susceptor 305, the temperature of the substrate W can be rapidly increased.

After the substrate W floats, levitates, or hovers above the susceptor 305, the substrate W can be heated by the gas supply unit 200 and the zone heater 410, 430 to a second process temperature, for example, a temperature of 100° C. or higher. Thereby, the process by-products generated on the upper surface of the substrate W can be removed by blowing.

The susceptor assembly and the substrate processing apparatus according to the present invention have the technical advantages as follows.

According to the present invention having the configuration described above, the single cooling path is provided in the susceptor to prevent the differences in the flow speeds or flow rates of the cooling fluid, and thus can maintain the constant or same temperature at the center and periphery of the substrate.

In addition, according to the present invention, when the high temperature process is performed after the low temperature process, the temperature of the substrate can be rapidly raised by floating or levitating the substrate above the susceptor.

Although a number of examples have been described, it should be understood that other modifications and implementations can be devised by those skilled in the art that will fall within the spirit and scope of the principles of the present invention. More particularly, various variations and modifications in the structure or the configuration are possible within the scope of the disclosure, the drawings, and the appended claims. In addition to variations and modifications in the configuration, alternative uses will also be apparent to those skilled in the art.

What is claimed is:

1. A susceptor assembly configured to support a substrate and to regulate a temperature of the substrate, the susceptor assembly comprising:
a susceptor on which the substrate is seated, the susceptor being configured to cool or heat the substrate and to supply levitational gas toward the substrate.

2. The susceptor assembly of claim 1, further comprising:
two or more zone heaters embedded in the susceptor and configured to heat the substrate; and
a cooling path disposed between the zone heaters and configured to allow cooling fluid to flow therethrough to cool the substrate.

3. The susceptor assembly of claim 2, wherein the zone heaters include:
a first zone heater configured to heat a center portion of the substrate; and
a second zone heater configured to heat a periphery of the substrate, and
wherein the cooling path is disposed between the first zone heater and the second zone heater in the susceptor.

4. The susceptor assembly of claim 1, wherein a plurality of supply holes are formed at an upper surface of the susceptor to supply the levitational gas toward a lower surface of the substrate, and
a reception space for accommodating the levitational gas and communicating with the supply holes is provided in an interior of the susceptor.

5. The susceptor assembly of claim 1, further comprising a plurality of anti-dislodgement pins configured to prevent the substrate from dislodging from the susceptor, while the substrate is levitated above the susceptor.

6. The susceptor assembly of claim 1, wherein the susceptor includes:
an upper susceptor on which the substrate is seated; and
a lower susceptor configured to support the upper susceptor, and
wherein the upper susceptor includes:
two or more zone heaters configured to heat the substrate; and
a cooling path disposed between the zone heaters and configured to allow cooling fluid to flow therethrough to cool the substrate.

7. The susceptor assembly of claim 6, wherein a plurality of supply holes are formed at an upper surface of the upper susceptor to supply the levitational gas toward a lower surface of the substrate, and
a reception space for accommodating the levitational gas and communicating with the supply holes, is provided between the upper susceptor and the lower susceptor.

8. A substrate processing apparatus comprising:
a chamber configured to provide a processing space for a substrate;
a gas supply unit provided in an upper portion of an interior of the chamber and configured to supply process gas toward the substrate; and
a susceptor assembly provided in the interior of the chamber and configured to allow the substrate to be seated thereon,
wherein the susceptor assembly includes:
a susceptor on which the substrate is seated, the susceptor being configured to cool or heat the substrate and to supply levitational gas toward the substrate;
two or more zone heaters embedded in the susceptor and configured to heat the substrate; and
a cooling path disposed between the zone heaters and configured to allow cooling fluid to flow therethrough to cool the substrate.

9. The substrate processing apparatus of claim 8, wherein a plurality of supply holes are formed at an upper surface of the susceptor to supply the levitational gas toward a lower surface of the substrate, and
a reception space for accommodating the levitational gas and communicating with the supply holes, is provided in an interior of the susceptor.

10. The substrate processing apparatus of claim 8, wherein the gas supply unit is provided with a lamp configured to heat the substrate.
